(19) United States
(12) Patent Application Publication
(10) Pub. No.: US 2021/0231120 A1
(43) Pub. Date: Jul. 29, 2021

(54) HIGH PRESSURE PUMP AND A PUMPING METHOD USING THE SAME

(71) Applicant: HUIZHOU HYDRO CARESYS MEDICAL CO., LTD., Huizhou (CN)

(72) Inventor: Fengling LUO, Huizhou (CN)

(21) Appl. No.: 17/169,494

(22) Filed: Feb. 7, 2021

Related U.S. Application Data
(63) Continuation of application No. PCT/CN2018/125104, filed on Dec. 28, 2018.

(30) Foreign Application Priority Data
Aug. 15, 2018 (CN) 201810930325.8

(51) Int. Cl. F04B 53/14

(52) U.S. Cl. CPC F04B 53/144; F04B 53/143

(57) ABSTRACT

A high-pressure pump includes a pump body provided with a piston cavity. A valve assembly and a piston are respectively provided at an end of the piston chamber. An outer end surface of the piston is connected to a push rod. An outer side wall of the piston is provided with a first recess. An outer end surface of the piston is provided with a mounting groove. The push rod is provided with a connecting rod, and an end of the connecting rod close to the piston is provided with an engaging portion, the outer diameter of the engaging portion is larger than the outer diameter of the connecting rod. A bottom of the mounting groove is provided with an engaging groove, and the engaging portion is fitted into the engaging groove. A pumping method using the high-pressure pump is also provided.

### CROSS-REFERENCE TO RELATED APPLICATIONS

This application is a continuation of International Patent Application No. PCT/CN2018/125104 with a filling date of Dec. 28, 2018, which claims the benefit of priority from Chinese Patent Application No. 201810930325.8 with a filing date of Aug. 15, 2018. The content of the aforementioned applications, including any intervening amendments thereto, is incorporated herein by reference.

### TECHNICAL FIELD

The present application relates to medical supplies and equipment, and more particularly to a high-pressure pump and a pumping method using the same.

### BACKGROUND

Traditional high-pressure pump for medical purpose usually includes a piston which is arranged inside a piston chamber of the pump body and is fixedly connected to a push rod. The displacement of the push rod drives the piston to slide in the piston chamber, and the piston reciprocates to change the pressure in the piston chamber which drives the fluid in the pump body to flow into or out of the piston chamber of the pump body.

Currently, the high-pressure pumps adopted in the medical technology mainly have the following defects.

1. Common connection modes between the piston and the push rod include screw connection, bonding, soldering, welding and interference fit, but the joining of components is complicated, which requires specific tools to assemble and disassemble.

2. It is hard to ensure the sealing performance between the piston and the piston chamber, which imposes very strict processing accuracy on the piston. Moreover, the unreliable sealing performance between the piston and the piston chamber generally leads to inaccurate open-and-shut control of the valve assembly.

### SUMMARY

In order to overcome the defects in the prior art, an object of the disclosure is to provide a high-pressure pump, which provides good sealing performance between the piston and the piston chamber of the pump body, firm connection between the piston and the push rod and simple disassembly, and is capable of working under large pressure difference.

To achieve the above object, the present disclosure provides a high-pressure pump, comprising a pump body; wherein the pump body is provided with a piston chamber; a valve assembly is provided at one end of the piston chamber, and a piston is slidably arranged at the other end of the piston chamber; and an outer end surface of the piston is connected to a push rod; an outer side wall of the piston is provided with a first recess in a circumferential direction, and both ends of the first recess elastically abuts an inner side wall of the piston chamber; the outer end surface of the piston is provided with a mounting groove; an end of the push rod close to the piston is provided with a connecting rod; an end of the connecting rod close to the piston is provided with an engaging portion; an outer diameter of the engaging portion is larger than an outer diameter of the connecting rod; a bottom of the mounting groove is provided with an engaging groove; an inner diameter of the engaging groove is larger than an inner diameter of the mounting groove; an outer diameter of the engaging portion is larger than an inner diameter of the mounting groove, such that when the connecting rod is inserted into the mounting groove, the connecting rod is in interference fit with the mounting groove; and the engaging portion is engaged with the engaging groove.

In an embodiment, the engaging portion comprises a first portion connected to the connecting rod and a second portion connected to the first portion; the first portion is cylindrical, and an outer diameter of the first portion is larger than an inner diameter of the engaging groove; the second portion has a truncated cone shape, and the second portion is tapered from one end close to the first portion.

In an embodiment, an end of the first recess close to the push rod is provided with a projection in a circumferential direction; and the projection is tapered from one end close to the push rod.

In an embodiment, a length of the projection along an axial direction of the piston is greater than 0.01 mm.

In an embodiment, an inner end surface of the piston is provided with a second recess.

In an embodiment, the second recess is bowl-shaped, and the second recess is tapered from one end away from the push rod.

In an embodiment, a wall thickness between an inner side wall of the second recess and the outer side wall of the piston along a radial direction of the piston is greater than 0.1 mm.

In an embodiment, the outer side wall of the piston comprises a first side wall and a second side wall from one end close to the push rod to the other end; an included angle is formed between the first side wall and the second side wall to form the first recess; an included angle between the second side wall and a central axis of the piston is 5°-90°; and the included angle between the first side wall and the second side wall is 60°-180°.

In a second aspect, the present disclosure provides a pumping method which uses the above high-pressure pump for fluid pumping; the push rod being engaged with the mounting groove of the piston through the engaging portion; both ends of the first recess being capable of abutting the piston chamber of the pump body and deforming under pressure; the method comprising: pushing, by the push rod, the piston to move in a direction approaching the valve assembly along the axial direction of the piston, wherein the piston is pushed by a front end of the push rod, and the inner side wall of the second recess of the piston receives fluid pressure, so that an end of the first recess away from the push rod is pressed along a radial direction of the piston to abut the inner side wall of the piston chamber to form a sealed space, during which the sealed space is reduced to create a high pressure state; and pulling, by the push rod, the piston to move in a direction away from the valve assembly along the axial direction of the piston, so that one end of the first recess close to the push rod is compressed along the radial direction of the piston to abut the inner side wall of the piston chamber, during which the sealed space is expanded to create a negative pressure state.

Compared to the prior art, the present invention has following beneficial effects. The present disclosure provides a high-pressure pump and a high-pressure pumping method. The outer side wall of the piston of the high-pressure pump is provided with a first recess in a circumferential direction, and both ends of the first recess elastically abuts the inner side wall of the piston chamber, which not only ensures the sealing performance between the piston and the piston chamber, but also reduces the processing difficulty of the piston. In addition, the push rod and the piston are connected through the engaging portion and the engaging groove, thus providing firm connection to withstand large pressure difference and convenience to disassemble and assemble.

### BRIEF DESCRIPTION OF THE DRAWINGS

FIG. 1 is a schematic diagram of a cross-sectional structure of a high-pressure pump according to an embodiment of the present disclosure.

FIG. 2 is an enlarged view of Detail A in FIG. 1 according to an embodiment of the present disclosure.

FIG. 3 is a cross-sectional exploded view showing a push rod and a piston of the high-pressure pump according to an embodiment of the present disclosure.

FIG. 4 is an enlarged view of Detail B in FIG. 3 according to an embodiment of the present disclosure.

In the drawings: 10, pump body; 11, piston chamber; 20, piston; 21, first recess; 22, mounting groove; 23, engaging groove; 24, projection; 25, second recess; 26, first side wall; 27, second side wall; 30, push rod; 31, connecting rod; 32, engaging portion; 321, embedded portion; 322, second portion; and 40, valve assembly.

### DETAILED DESCRIPTION OF EMBODIMENTS

The present disclosure will be further described in detail below with reference to the accompanying drawings and the embodiments. The embodiments disclosed in the present disclosure are only illustrative, but not intended to limit the scope of the present disclosure.

In the description of the present disclosure, it should be understood that the orientation or positional relationship indicated by the terms “up”, “down”, “left”, “right”, “top” and “bottom” is based on the orientation or positional relationship shown in the accompanying drawings. These terms are only for the convenience of describing the present disclosure and simplifying the description, rather than indicating or implying that the device or element must have a specific orientation, or is constructed and operated in a specific orientation, and therefore cannot be interpreted as limiting the present disclosure. It should be understood that the terms “first” and “second” used herein are to describe various information, but these information should not be limited to these terms, and these terms are only adopted to distinguish the same type of information from each other. For example, without departing from the scope of the present disclosure, the “first” information may be referred to as the “second” information; similarly, the “second” information may be referred to as the “first” information.

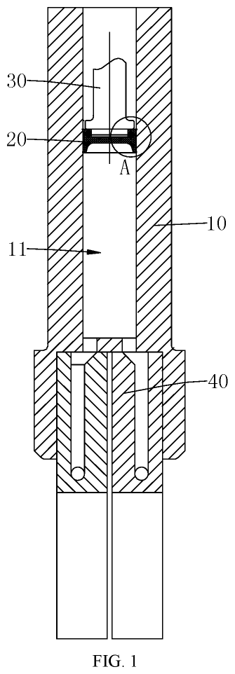

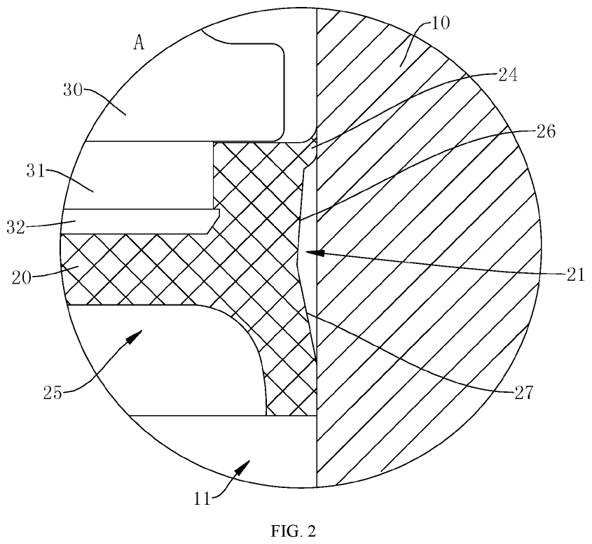

As shown in FIGS. 1-3, in a preferred embodiment of the present disclosure, provided is a high-pressure pump including a pump body 10. The pump body 10 is provided with a piston chamber 11. A valve assembly 40 is provided at one end of the piston chamber 11, and a piston 20 is slidably arranged at the other end of the piston chamber 11. A push rod 30 is connected to an outer end surface of the piston 20. The push rod 30 can move toward or away from the valve assembly 40 to drive the piston 20 to slide back and forth in the piston chamber 11. The piston 20 is made of a flexible material.

The outer side wall of the piston 20 is provided with a first recess 21 in a circumferential direction. The maximum outer diameters of both ends of the first recess 21 are larger than the inner diameter of the piston chamber 11, so that both ends of the first recess 21 elastically abuts the inner side wall of the piston chamber 11.

The outer end surface of the piston 20 is provided with a mounting groove 22. An end of the push rod 30 close to the piston 20 is provided with a connecting rod 31, and one end of the connecting rod 31 is provided with an engaging portion 32. An outer diameter of the engaging portion 32 is larger than an outer diameter of the connecting rod 31. A bottom of the mounting groove 22 is provided with an engaging groove 23, and an inner diameter of the engaging groove 23 is larger than an inner diameter of the mounting groove 22. An outer diameter of the engaging portion 32 is larger than an inner diameter of the mounting groove 22, such that when the connecting rod 31 is inserted into the mounting groove 22, the connecting rod 31 is in interference fit with the mounting groove 22, and the engaging portion 32 is engaged with the engaging groove 23. Specifically, the outer side wall of the engaging portion 32 abuts against the inner side wall of the engaging groove 23, and the outer side wall of the connecting rod 31 abuts against the inner side wall of the mounting groove 22.

Based on the above-mentioned technical solution, this embodiment provides a high-pressure pump, in which the outer side wall of the piston 20 is provided with a first recess 21, and the part of the outer side wall other than both ends of the first recess 21 is not in contact the inner side wall of the piston chamber 11, thereby ensuring a smooth movement of the piston 20. Since there is no need to ensure that the entire outer side wall of the piston 20 is in contact with the piston chamber 11, the manufacturing accuracy requirements for the piston 20 is greatly reduced. The two ends of the first recess 21 elastically abut the inner side wall of the piston chamber 11 to form an effective seal to the piston chamber 11. The contact area between the outer side wall of the piston 20 and the piston chamber 11 is reduced to increase the degree of elastic deformation of the piston 20 in a radial direction and improve the sealing effect between the outer side wall of the piston 20 and the inner side wall of the piston chamber 11. In addition, the push rod 30 in the high-pressure pump is engaged with the piston 20, and the outer side wall of the engaging portion 32 abuts against the inner side wall of the engaging groove 23, which can ensure that the push rod 30 is firmly connected to the piston 20. Therefore, the pressure difference is relatively large without impact to the service life of the piston 20. Moreover, compared to the traditional connection methods such as screw connection, the disassembly and assembly operations become simpler.

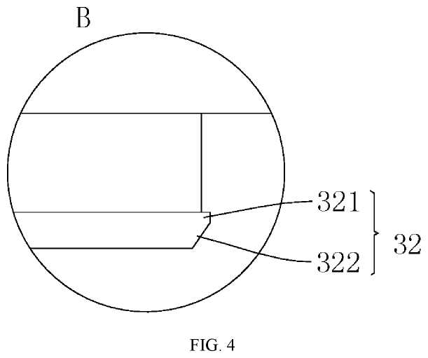

In the embodiment, referring to FIG. 4, in order to allow the push rod 30 to be easily inserted into the piston 20, or to be detached from the piston 20, the engaging portion 32 includes a first portion 321 connected to the connecting rod 31 and a second portion 322 connected to the first portion 321. The first portion 321 is cylindrical, and an outer diameter of the first portion 321 is larger than an inner diameter of the engaging groove 23. The second portion 322 has a truncated cone shape, and is tapered from one end close to the first portion 321 to form the engaging portion 32 with an inverted truncated cone shape. When mounting the push rod 30, firstly the second portion 322 is pushed to slide into the engaging groove 23, and then the piston 20 is pushed to lock the first portion 321 into the engaging groove 23, the engaging portion 32 is engaged with the engaging groove 23. Therefore, the high-pressure pump has a stable connection structure, which can operate under a large pressure difference.

Further, in the embodiment, the outer diameter of an end of the push rod 30 close to the connecting rod 31 is greater than the outer diameter of the connecting rod 31. After the engaging portion 32 is engaged with the engaging groove 23, one end of the push rod 30 close to the connecting rod 31 partly abuts against the outer end surface of the piston 20, to prevent deformation of the main body of the piston 20 except the part where the two ends of the piston 20 are in contact with the piston chamber 11 when the push rod 30 pushes the piston 20 to move closer to or away from the valve assembly 40

Specifically, an end of the first recess 21 in the embodiment close to the push rod 30 is provided with a projection 24 in a circumferential direction. The maximum outer diameter of the projection 24 is larger than the inner diameter of the piston chamber 11, such that one end of the first recess 21 close to the push rod 30 can elastically deforms and abuts the inner wall of the piston chamber 11 by the projection 24, and the projection 24 is tapered from one end close to the push rod 30 to the other end, allowing for good sealing between the outer side wall of the piston 20 and the piston chamber 11.

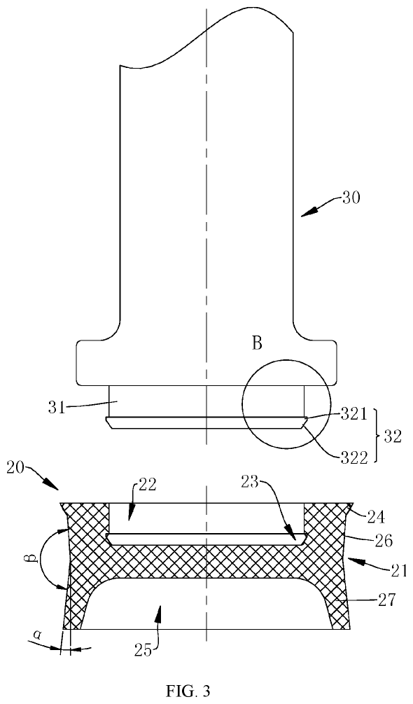

Exemplarily, the outer side wall of the projection 24 is arranged obliquely. Referring to FIG. 3, the projection 24 has a triangle longitudinal section. The longitudinal section of the projection 24 may be in other shapes, such as quadrangle and trapezoid. when the push rod 30 pushes the piston 20 to slide in the direction close to the valve assembly 40 along the axial direction of the piston 20, the pressure in the piston chamber 11 increases, and the projection 24 deforms in a radial direction of the piston 20 while being pressed along the axial direction of the piston 20 towards the direction close to the push rod 30, which contributes to the sealing performance between the projection 24 and the inner side wall of the piston chamber 11. When the push rod 30 pulls the piston 20 along the axial direction of the piston 20 and slides away from the valve assembly 40, negative pressure is created in the piston chamber 11, and the projection 24 is pressed and deformed in the radial direction of the piston 20 while being pressed along the axial direction of the piston 20 away from the push rod 30, which contributes to the sealing performance between the projection 24 and the inner wall of the piston wall 11 and preventing air from being mixed into the fluid in the piston chamber 11. Moreover, the operation stability of the high-pressure pump is improved, the service life of the pump body 10 is prolonged, and the risk of failure during operation is reduced. For example, the included angle between the outer side wall of the projection 24 and the central axis of the piston 20 is 15°-75°.

In an embodiment, in order to ensure the strength and service life of the projection 24, a length of the projection 24 along an axis of the piston 20 is greater than 0.01 mm. Exemplarily, the length of the projection 24 in the axial direction of the piston 20 is smaller than the length of the outer side wall of the first recess 21 in the axial direction of the piston 20, so as not to cover the outer side wall of the first recess 21.

Based on the above technical solution, the inner end surface of the piston 20 in the embodiment is provided with a second recess 25. During the movement of the piston 20, when the pressure in the piston chamber 11 is high, the second recess 25 is filled with high-pressure fluid which pushes the wall between the second recess 25 and the outer side wall of the piston 20 to press outward along the radial direction of the piston 20, to further improve the airtight performance between the outer side wall of the piston 20 and the inner side wall of the piston chamber 11.

In the embodiment, in order to further improve the sealing performance between the outer side wall of the piston 20 and the inner side wall of the piston chamber 11, the second recess 25 is bowl-shaped, and is tapered from one end away from the push rod 30 to the other end.

Specifically, in order to meet the strength requirements of the piston 20, the wall thickness between the inner side wall of the second recess 25 and the outer side wall of the piston 20 along the radial direction of the piston 20 is greater than 0.1 mm.

Referring to the embodiment in FIG. 3, it can be seen that the outer side wall of the piston 20 includes a first side wall 26 and a second side wall 27 from one end close to the push rod 30 to the other end. An included angle is formed between the first side wall 26 and the second side wall 27 to form the first recess 21. The included angle between the second side wall 27 and the central axis of the piston 20 is α, where α=5°-90°. The included angle between the first side wall 26 and the second side wall 27 is β, where β=60°-180°. Therefore, the sealing performance between the outer side wall of the piston 20 and the inner side wall of the piston chamber 11 is ensured, and the piston 20 can slide smoothly in the piston chamber 11. In addition, the strength and service life of the piston 20 are improved by such design.

The embodiment of the present disclosure also provides a fluid pumping method using any one of the above high-pressure pumps. Through the engaging portion 32, the push rod 30 is engaged with the mounting groove 22 of the piston 20. Both ends of the first recess 21 can abut the piston chamber 11 of the pump body 10 and deform under pressure. When the push rod 30 pushes the piston 20 to move in a direction approaching to the valve assembly 40 along the axial direction of the piston 20, the front end of the push rod 30 pushes the piston 20, and the inner side wall of the second recess 25 of the piston 20 receives fluid pressure, so that the end of the first recess 21 away from the push rod 30 is pressed along the radial direction of the piston 20 to tightly abut the inner side wall of the piston chamber 11 to form a sealed space, during which the sealed space is reduced to create a high pressure state. When the push rod 30 pulls the piston 20 to move away from the valve assembly 40 along the axial direction of the piston 20, one end of the first recess 21 close to the push rod 20 is compressed along the radial direction of the piston 20 to tightly abut the inner side wall of the piston chamber 11 to form a sealed space, during which the sealed space is expanded to create a negative pressure state. By using this high-pressure pumping method, the seal of the inner side wall between the piston 20 and the piston chamber 11 can be improved during the movement process. Therefore, the push rod 30 is firmly connected to the outer end surface of the piston 20 to withstand a large pressure difference. In addition, it is easy to disassemble and assemble. Specifically, the end of the first recess 21 away from the push rod 30 and the projection 24 can abut the piston chamber 11 of the pump body 10 and deform under pressure.

The embodiments of the present disclosure provide a high-pressure pump and a high-pressure pumping method. The high-pressure pump includes a pump body 10, a piston 20, and a push rod 30. The outer side wall of the piston 20 is provided with a first recess 21 in a circumferential direction, and both ends of the first recess 21 elastically abut the inner side wall of the piston chamber 11 of the pump body 10, which can not only enhance the seal between the piston 20 and the pump body 10, but also reduce the manufacturing accuracy requirements of the piston 20. In addition, the push rod 30 is in interference fit with the piston 20 through the engagement between the engaging portion 32 and the mounting groove 22. By means of the present invention, it is easy and simple to assemble and disassemble, and a firm connection between the push rod 30 and the piston 20 is realized to withstand a large pressure difference.

Described above are only preferred embodiments of the present disclosure, which are not intended to limit the present invention. It should be noted that all equivalent changes made by those skilled in the art without departing from the spirit of the present disclosure shall fall within the scope as defined by the appended claims.

What is claimed is:

1. A high-pressure pump, comprising a pump body;
wherein the pump body is provided with a piston chamber; a valve assembly is provided at one end of the piston chamber, and a piston is slidably arranged at the other end of the piston chamber; and an outer end surface of the piston is connected to a push rod;
an outer side wall of the piston is provided with a first recess in a circumferential direction, and both ends of the first recess elastically abut an inner side wall of the piston chamber;
the outer end surface of the piston is provided with a mounting groove; an end of the push rod close to the piston is provided with a connecting rod; an end of the connecting rod close to the piston is provided with an engaging portion; an outer diameter of the engaging portion is larger than an outer diameter of the connecting rod; a bottom of the mounting groove is provided with an engaging groove; an inner diameter of the engaging groove is larger than an inner diameter of the mounting groove; an outer diameter of the engaging portion is larger than an inner diameter of the mounting groove, such that when the connecting rod is inserted into the mounting groove, wherein the connecting rod is in interference fit with the mounting groove; and the engaging portion is engaged with the engaging groove.

2. The high-pressure pump of claim 1, wherein the engaging portion comprises a first portion connected to the connecting rod and a second portion connected to the first portion; the first portion is cylindrical, and an outer diameter of the first portion is larger than an inner diameter of the engaging groove; the second portion has a truncated cone shape, and the second portion is tapered from one end close to the first portion.

3. The high-pressure pump of claim 1, wherein an end of the first recess close to the push rod is provided with a projection in a circumferential direction; and the projection is tapered from one end close to the push rod.

4. The high-pressure pump of claim 3, wherein a length of the projection along an axial direction of the piston is greater than 0.01 mm.

5. The high-pressure pump of claim 1, wherein an inner end surface of the piston is provided with a second recess.

6. The high-pressure pump of claim 5, wherein the second recess is bowl-shaped, and the second recess is tapered from one end away from the push rod.

7. The high-pressure pump of claim 5, wherein a wall thickness between an inner side wall of the second recess and the outer side wall of the piston along a radial direction of the piston is greater than 0.1 mm.

8. The high-pressure pump of claim 1, wherein the outer side wall of the piston comprises a first side wall and a second side wall from one end close to the push rod to the other end; an included angle is formed between the first side wall and the second side wall to form the first recess; an included angle between the second side wall and a central axis of the piston is 5°-90°; and the included angle between the first side wall and the second side wall is 60°-180°.

9. A pumping method using the high-pressure pump of claim 1, the push rod being engaged with the mounting groove of the piston through the engaging portion;
both ends of the first recess being capable of abutting the piston chamber of the pump body and deforming under pressure; the method comprising:
pushing, by the push rod, the piston to move in a direction approaching the valve assembly along the axial direction of the piston, wherein the piston is pushed by a front end of the push rod, and the inner side wall of the second recess of the piston receives fluid pressure, so that an end of the first recess away from the push rod is pressed along a radial direction of the piston to abut the inner side wall of the piston chamber to form a sealed space, during which the sealed space is reduced to create a high pressure state; and
pulling, by the push rod, the piston to move in a direction away from the valve assembly along the axial direction of the piston, so that one end of the first recess close to the push rod is compressed along the radial direction of the piston to abut the inner side wall of the piston chamber, during which the sealed space is expanded to create a negative pressure state.
